(19) United States
(12) Patent Application Publication
(10) Pub. No.: US 2016/0295063 A1
(43) Pub. Date: Oct. 6, 2016

(54) TABLET COMPUTER WITH INTEGRATED SCANNER

(71) Applicant: Abdifatah Farah, Blacklick, OH (US)

(72) Inventor: Abdifatah Farah, Blacklick, OH (US)

(21) Appl. No.: 15/090,593

(22) Filed: Apr. 4, 2016

Related U.S. Application Data
(60) Provisional application No. 62/142,642, filed on Apr. 3, 2015.

(51) Int. Cl. H04N 1/12; G06F 1/16; G06F 3/0354; H04N 1/04

(52) U.S. Cl. CPC H04N 1/121; H04N 1/04; G06F 1/1696; G06F 3/03545; H04N 2201/0081; H04N 2201/0096; H04N 2201/043

(57) ABSTRACT

A tablet computer with an integrated document scanner that is adapted to transport paper documents through a scanning pathway in the tablet body and to scan said documents. Scanned documents may be saved to internal tablet memory for subsequent access. A stylus that permits a user to write or highlight on scanned documents in different selectable colors may also be associated with a scanning tablet.

### CROSS-REFERENCE TO RELATED APPLICATIONS

This application claims the benefit of U.S. Provisional Application No. 62/142,642, filed on Apr. 3, 2015, which is hereby incorporated by reference as if fully recited herein.

### TECHNICAL FIELD

Exemplary embodiments described herein are directed to a digital tablet with an integrated scanner for scanning documents and other papers.

### BACKGROUND

Currently there are a number of solutions for organizing important paper documents such as may be associated with home, school or office functions. Some of these solutions attempt to maintain all such documents in files, but these solutions fail to meet the needs of the market because of resulting space issues and difficulties concomitant with accessing a high volume of documents.

Other solutions attempt to deal with this problem by scanning paper documents and subsequently saving an electronic version thereof. Unfortunately, most scanners are not portable and post-scanning storage of electronic documents commonly requires additional steps that make organization tedious if not actually difficult. Still other electronic solutions are operative to scan, photograph or otherwise image documents, but these solutions also fail to meet market needs because documents imaged in this manner are harder to interact with, such as if a user needs to make notes, highlight or otherwise edit or alter a document.

It can be understood from the foregoing remarks that there is a need for a document storage solution that overcomes the deficiencies of known document organization systems and techniques. The exemplary tablet embodiments described herein meet this need.

### SUMMARY

As described above, it would be highly useful to provide a simple and efficient device for reducing the volume of documents that must be retained by most individuals, and for additionally organizing said documents in a manner that facilitates navigation, viewing and retrieval of said documents. As used herein, the term “documents” is intended to encompass written text, photographs, drawings, and virtually any other work that may be embodied on paper or a paper-like substrate that is capable of being electronically scanned.

Exemplary device embodiments described herein are, generally speaking, digital computing devices with display and input means, preferably having a form factor commonly referred to as a tablet computer (or more commonly simply as a tablet), and include integrated document scanning functionality. More particularly, exemplary scanning tablet embodiments include a motorized pass-through scanner that is adapted to feed documents of interest through a scanning pathway that passes through the tablet body. An image scanner (scanner) is integrated into the scanning tablet such that documents are optically scanned as they pass through the scanning pathway in the tablet and converted to a digital image.

Once a document has been scanned using an exemplary scanning tablet, it may be stored in tablet memory and/or external memory, electronically transmitted to another location or device, printed, etc. Specialized software associated with an exemplary scanning tablet may facilitate the storage and organization of scanned documents.

A user may have the ability to place notes on scanned documents, or to otherwise edit scanned documents using an exemplary scanning tablet. Exemplary scanning tablet embodiments may include an associated stylus for this purpose. For example, an exemplary stylus may permit a user to write on and/or highlight scanned documents stored on an associated scanning tablet. An exemplary stylus may cooperate with exemplary scanning tablet software to permit a user to selectively write and/or highlight using different colors that are selectable from the stylus. Likewise, the functionality of the stylus (i.e., writing instrument or highlighter) may also be selectable from the stylus.

Exemplary scanning tablet embodiments may also include other functionality such as, without limitation, the ability to take screenshots and record audio. An exemplary scanning tablet embodiment may also include a still image camera(s) and/or video camera(s), an external speaker, a headphone jack, a charging port(s), various hard buttons for controlling tablet functions, etc. Essentially, any feature present on known tablets may be incorporated into an exemplary scanning tablet embodiment. Likewise, accessories that are usable with known mobile devices such as existing mobile phones and tablets may be usable with an exemplary scanning tablet embodiment (e.g., keyboards).

Similarly, it is contemplated that scanning tablet embodiments described herein may employ different software operating systems. For example, it is contemplated that an exemplary scanning tablet embodiment may employ any operating system currently known for use with mobile devices such as existing mobile phones and tablets.

Other aspects and features of the invention will become apparent to those skilled in the art upon review of the following detailed description of exemplary embodiments along with the accompanying drawing figures.

### BRIEF DESCRIPTION OF THE DRAWINGS

In the following descriptions of the drawings and exemplary embodiments, like reference numerals across the several views refer to identical or equivalent features, and:

FIGS. 1A-1B are perspective views of one exemplary scanning tablet embodiment;

FIGS. 2A-2B are additional perspective views of the exemplary scanning tablet embodiment of FIGS. 1A-1B;

FIG. 3A schematically illustrates a front view of one exemplary scanning tablet embodiment;

FIG. 3B schematically illustrates a rear view of one exemplary scanning tablet embodiment;

FIG. 4A schematically illustrates a left side view of one exemplary scanning tablet embodiment;

FIG. 4B schematically illustrates a right side view of one exemplary scanning tablet embodiment;

FIG. 5A schematically illustrates a top view of one exemplary scanning tablet embodiment;

FIG. 5B schematically illustrates a bottom view of one exemplary scanning tablet embodiment;

FIG. 6 depicts an exemplary scanning tablet embodiment in the process of scanning a document;

FIG. 7 is a flow chart showing the steps of one exemplary method of operating an exemplary scanning tablet embodiment to scan a paper document of interest; and

FIG. 8 schematically illustrates an exemplary stylus that may be used with an exemplary tablet embodiment.

### DETAILED DESCRIPTION OF THE EXEMPLARY EMBODIMENTS

It is to be understood that a scanning tablet is not limited to the particular examples set forth herein and may, instead, vary to some extent in appearance and design while maintaining the desired functionality. Consequently, various changes may be made to the described exemplary embodiments and equivalents may be substituted without departing from the true spirit and scope of the invention.

Unless otherwise indicated, the words and phrases presented in this document have their ordinary meanings to one of skill in the art. Such ordinary meanings can be obtained by reference to their use in the art and by reference to general and scientific dictionaries.

References in the specification to “an exemplary embodiment” or to “one exemplary embodiment” indicate that the embodiment described may include a particular feature, structure, or characteristic, but other embodiments may not necessarily include the particular feature, structure, or characteristic. Moreover, it is submitted that when a particular feature, structure, or characteristic is described in connection with a given exemplary embodiment, it is within the knowledge of one skilled in the art to affect such feature, structure, or characteristic in connection with other embodiments whether or not explicitly described.

As used herein, the singular forms “a,” “an,” and “the” include plural reference unless the context clearly dictates otherwise. As used herein, the terms “include,” “for example,” “such as,” and the like are used illustratively and are not intended to limit the present invention.

As used herein, the terms “front,” “back,” “rear,” “upper,” “lower,” “right,” and “left” are merely used to better describe various elements of the exemplary embodiments as they are oriented in the drawing figures, and said terms are not to be construed as limiting in any way.

These terms are not meant to limit the elements that they describe, as the various elements may be oriented differently in various applications.

It is also to be understood that, while the terms first, second, etc., may be used herein to describe various elements, said elements are not limited by such terms. Rather, such terms are used only to distinguish one element from another.

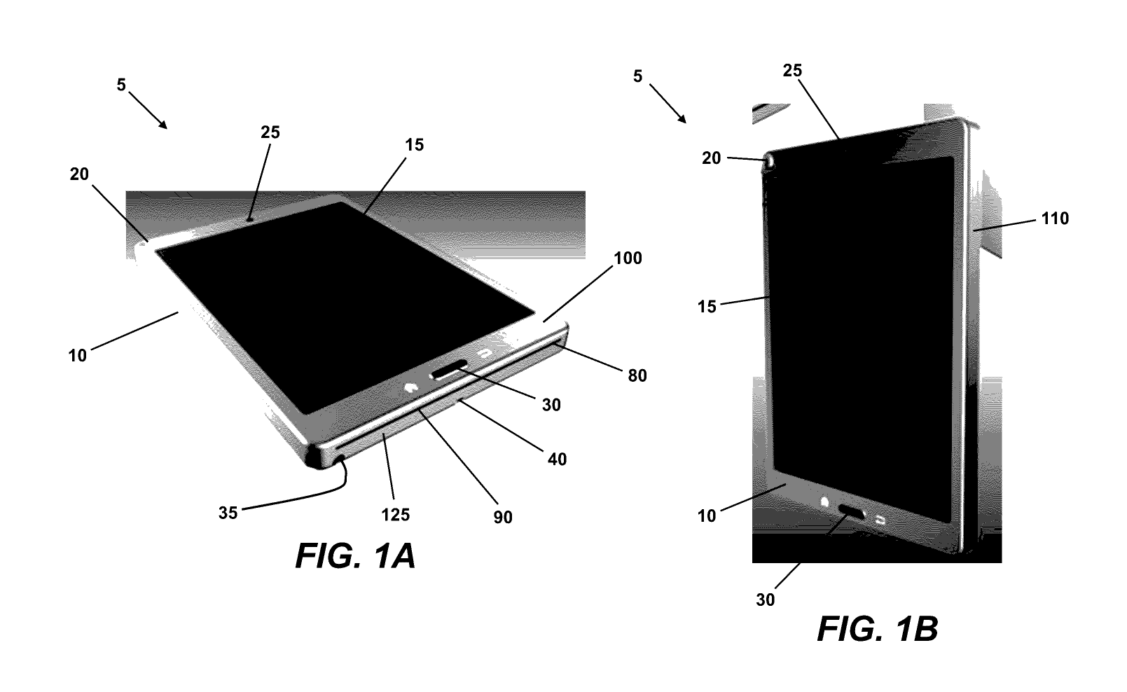

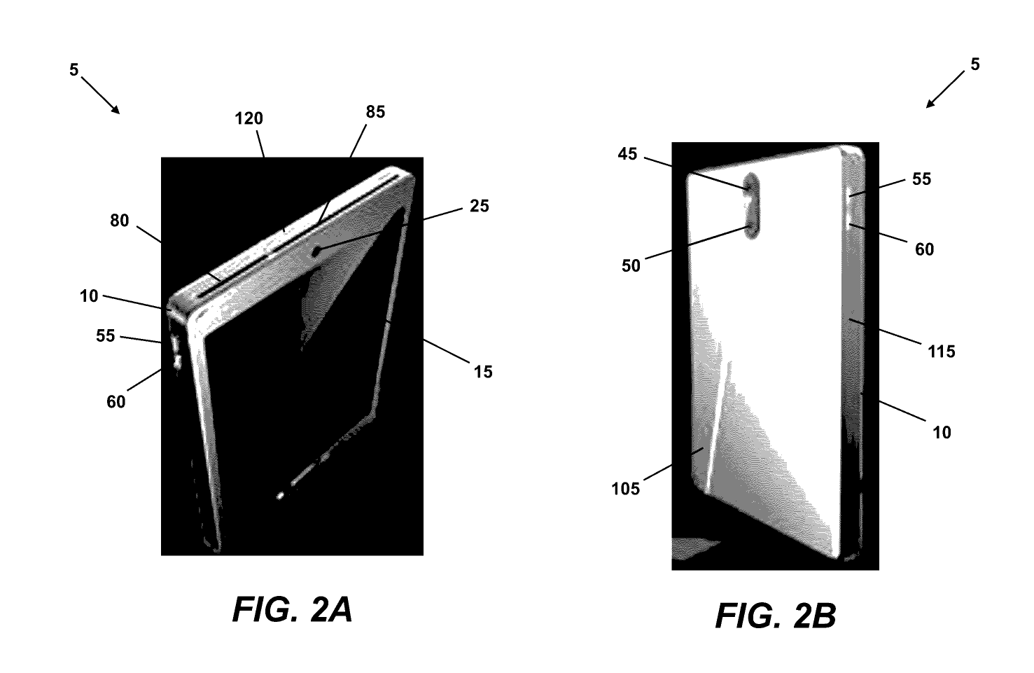

As generally explained above, the exemplary device embodiments described below and illustrated in the accompanying drawing figures are tablet computers (tablets) with integrated document scanning functionality. One such exemplary scanning tablet 5 is illustrated generally in FIGS. 1A-1B and 2A-2B. As shown therein, the scanning tablet 5 includes a body 10 having a front face 100, a back face 105, a right side 110, a left side 115, a top side 120 and a bottom side 125. In this case, the body 10 is of substantially rectangular shape, but other shapes and dimensions may be employed in other embodiments.

The scanning tablet 5 is also shown to include a display 15 on which a user may view scanned documents and, when such functionality is present, read other types of documents, watch videos, browse the Internet, etc. The type of display 15 provided may vary from a simple LCD display to a full color high-definition or ultra-high-definition display. Generally speaking, any type of display that is currently known to be usable on existing devices such as mobile tablets and phones or laptop computers, or any such display that becomes known in the future, may be incorporated into a scanning tablet embodiment.

While not visible in the drawing figures, it would be apparent to one of skill in the art that the exemplary scanning tablet 5 also includes a microprocessor and associated circuitry. Similarly, the exemplary scanning tablet 5 includes a power source such as a battery, and memory for storing programs and data (e.g., scanned documents).

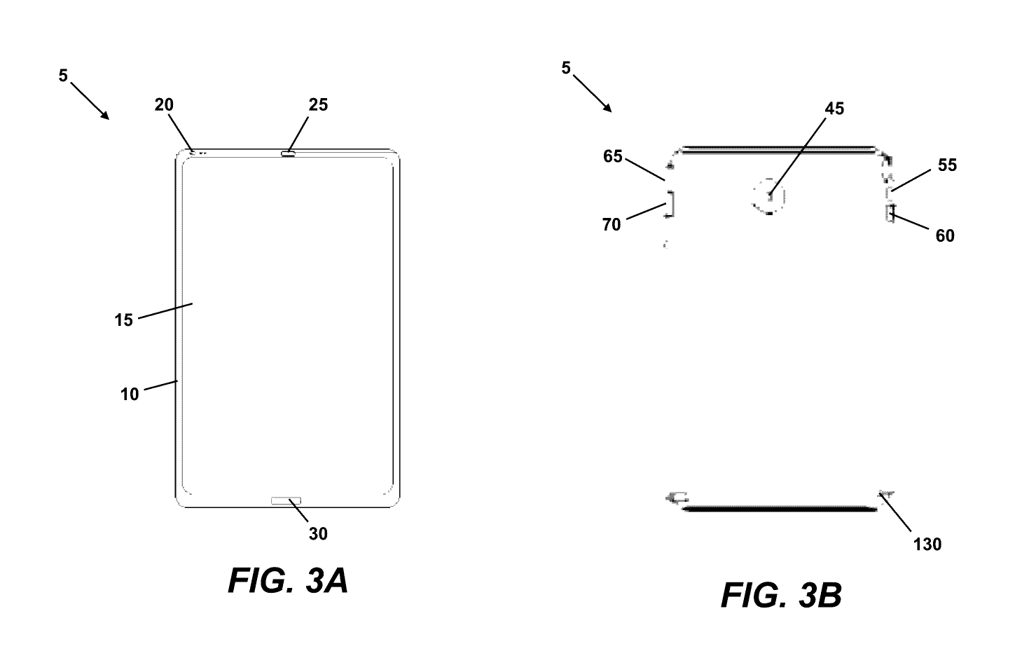

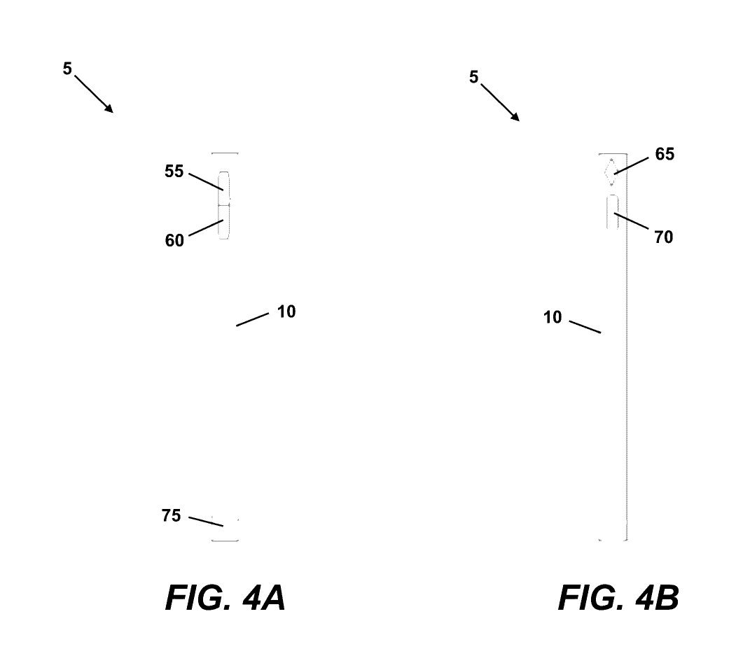

A number of other optional scanning tablet features are illustrated in FIGS. 1A-1B and 2A-2B. For example, the exemplary scanning tablet 5 is shown to include a notification light 20, a front-facing camera 25, a home button 30, a headphone jack 35, a charging port 40, a rear-facing camera 45 and associated flash 50, various control and/or power buttons 55, 60, 65, 70, and an external speaker 75. As may be observed in FIG. 3B, an exemplary scanning tablet may also include a stylus port/dock 130 that is adapted to retain and possibly recharge a stylus (described in more detail below) that may be used with an exemplary scanning tablet. These optional features are additionally illustrated in the schematic representations of the scanning tablet 5 that appear in FIGS. 3A-5B. When present, each of these features would have the same general functionality as do similar features on existing devices such as known mobile phones and tablets. As such functionality would be well understood by one of skill in the art, no further description thereof need be provided herein. While said features are present on this particular example of a scanning tablet, it should be understood that some or all of said features may be absent from other embodiments. Contrarily, other exemplary scanning tablet embodiments may include features not shown or described herein, whether alone, or in combination with one or more of the shown and described features.

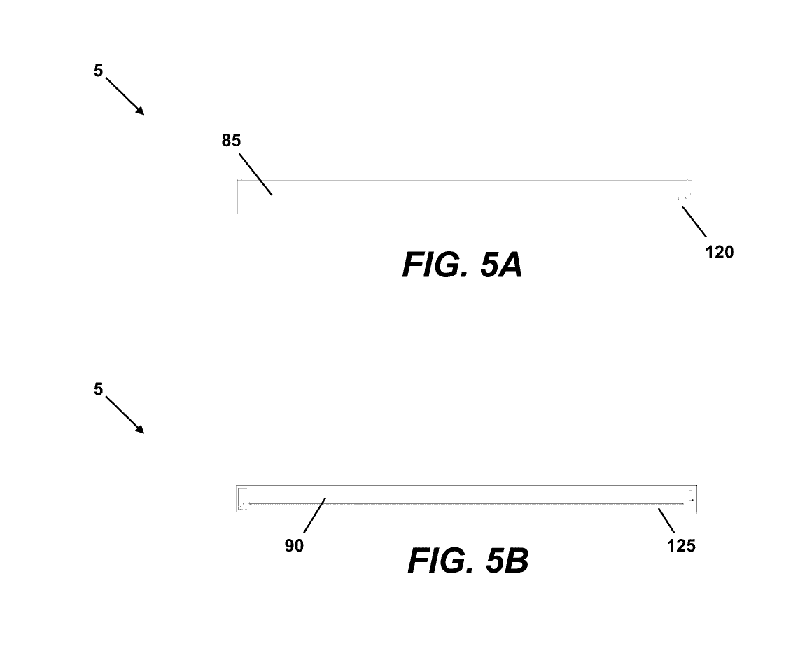

As can be best observed in FIG. 1A, FIG. 2A, and FIGS. 5A-5B, the exemplary scanning tablet 5 includes an integrated and motorized pass-through image scanner (not visible) that is adapted to feed documents of interest through a scanning pathway 80 that passes through the tablet body 10. To this end, the scanning tablet 5 includes a document intake port 85 in the upper edge of the body 10 and a document ejection port 90 in the lower edge the body 10. In other embodiments, the location of the document intake port 85 and document ejection port 90 may be reversed.

In use, the integrated image scanner (scanner) is operative to optically scan documents as they are passed through the scanning pathway 80 under the motorized control of the scanning tablet 5, and to convert the scanned documents into corresponding digital images. The scanner utilized in a given scanning tablet may vary in design and construction.

Generally speaking, however, the scanner will typically comprise at least an illumination source (e.g., a lamp, LEDs, a laser, etc.), an image capture device such as but not limited to a CCD camera, a document transport mechanism including a drive motor and associated control electronics, and a document conveyance element such a drive belt that pulls a document through the scanning pathway 80 when driven by the drive motor. A sheet of glass or a similar material may also be disposed along one side of the gap formed by the scanning pathway 80 and on the opposite side of the gap from the drive belt. The inclusion of such a sheet of glass or similar material may provide a smooth and transparent surface against which a document may be pressed and through which the document may be scanned as it is transported along the scanning pathway 80, as would be understood by one of skill in the art. Other scanner components, designs and interactions of components may also be utilized, as would also be understood by one of skill in the art.

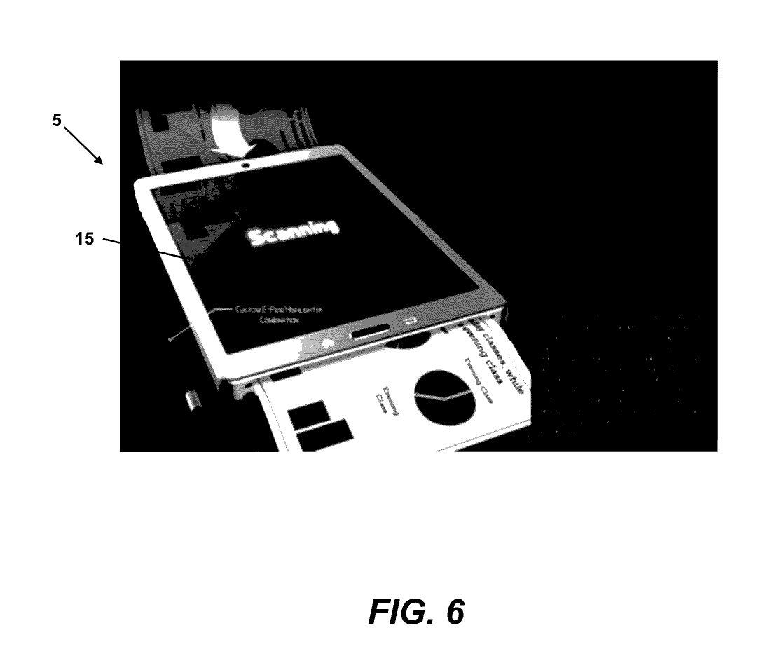

Operation of the exemplary scanning tablet 5 to scan a document is represented in FIG. 6. As shown, a document has been fed into the document intake port of the tablet 5 and is being fed through the scanning pathway within the tablet body under the motorized control of the tablet. The lead end of the document is shown being expelled from the document ejection port.

As depicted in FIG. 6, a document being scanned may be displayed on the display 15 of the exemplary scanning tablet 5 during the scanning process. Alternatively, or in addition thereto, a status indicator may be provided, such as but not limited to presentation of the word “Scanning” as shown in FIG. 6. A percentage of scanning completion may also or instead be displayed as a numerical value or a bar graph. Other possibilities also, of course, exist.

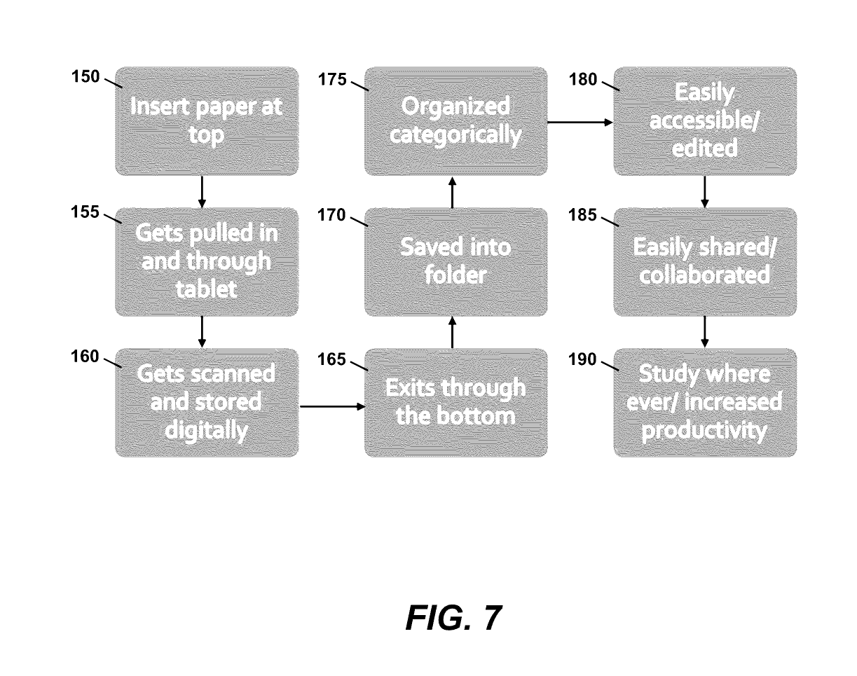

FIG. 7 shows a chart that indicates the steps of operation that occur during one exemplary document scanning process using one exemplary scanning tablet. A document to be scanned is initially inserted 150 into a document intake port located in a top face of an exemplary scanning tablet, whereafter the document is automatically detected and pulled into and through 155 the scanning pathway of the tablet by the motorized drive portion of the integrated scanner. The document is scanned by the scanner and stored 160 as a digital image in the memory of the tablet, and is ejected 165 from the scanning pathway at the opposite end of the tablet upon completion of the scanning operation. It may also or instead be possible to store scanned documents in auxiliary memory such as on a SD or micro-SD card, on a flash drive, etc.

As indicated in FIG. 7, an exemplary scanning tablet and its associated software may permit scanned documents to be saved into a particular folder 170 or into one of several selectable folders in the tablet memory (or associated memory). An exemplary scanning tablet and its associated software may also permit scanned documents to be organized categorically 175 for ease of subsequent location, retrieval, viewing, editing, etc. 180. Likewise, documents saved by an exemplary scanning tablet embodiment may also be easily shared 185. As indicated, distilling a large volume of paper documents into digital form and storing said documents in an organized and easily retrievable manner on a compact and highly transportable scanning tablet may allow the scanned and stored documents to be accessed almost anywhere, which may lead to an increase in user productivity 190.

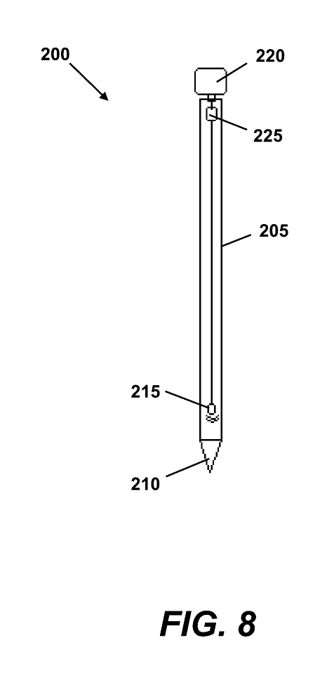

It is contemplated that exemplary scanning tablet embodiments may permit a user to place notes on scanned documents, or to otherwise edit scanned documents. Exemplary scanning tablet embodiments may include an associated stylus for this purpose. One such exemplary stylus 200 is depicted in FIG. 8. The stylus 200 includes a body portion 205 for gripping by a user and a tip portion 210 for contacting the display screen of an exemplary scanning tablet to make selections, write, draw, etc.

This exemplary stylus 200 is also adapted to permit a user to selectively write on and/or highlight portions of scanned documents saved on the tablet using different colors. The exemplary stylus 200 is provided with an internal transmitter 215 that is adapted to send a signal to cooperating software or other programming of an associated exemplary scanning tablet that indicates the mode in which the user desires to use the stylus (i.e., writing/drawing instrument or highlighter), as well as the color in which the user desires to write, draw or highlight, may also be selectable from the stylus. These selections may be made by pressing and/or rotating a cap 220 that is located at the opposite end of the stylus 200 from the tip 210. For example, the cap 220 may be pressed until the desired function or color is indicated on the stylus 200 and/or the associated tablet. In some embodiments one selection (mode or color) may be made by pressing the cap 220 while the other selection is made by rotating the cap. The cap 220 is in electronic communication with a switch, sensor, etc., 225 that is also located within the stylus body 205. The switch, sensor, etc., 225, in turn, communicates to the transmitter 215 the mode and color selections made using the cap 220.

Exemplary scanning tablet embodiments described herein may employ different software operating systems. For example, it is contemplated that an exemplary scanning tablet embodiment may employ any operating system currently known for use with mobile devices such as existing mobile phones and tablets (e.g., Android® or Microsoft® Windows®). Other software applications for controlling document scanning, facilitating document editing, storage or retrieval, and applications associated with other features may also be installed on an exemplary scanning tablet and interact with the tablet operating system and hardware as would be understood by one of skill in the art.

Exemplary scanning tablet embodiments may also include other functionality such as, without limitation, the ability to take screenshots and record audio. Essentially, any feature present on known tablets may be incorporated into an exemplary scanning tablet embodiment. Likewise, accessories that are usable with known mobile devices such as existing mobile phones and tablets may be usable with an exemplary scanning tablet embodiment (e.g., keyboards).

While certain embodiments of the invention are described in detail above, the scope of the invention is not considered limited by such disclosure, and modifications are possible without departing from the spirit of the invention as evidenced by the following claims:

What is claimed is:

1. A scanning tablet computer, comprising:
a tablet body;
a microprocessor, memory and a power source located within the tablet body;
an image scanner located within the tablet body and adapted to feed paper documents to be scanned through a scanning pathway passing through the tablet body; and
operating system software stored in tablet memory for controlling document scanning and other functions of the scanning tablet.

2. The scanning tablet computer of claim 1, further comprising a document intake port and a document ejection port associated with the scanning pathway.

3. The scanning tablet computer of claim 2, wherein the image scanner includes a motorized document transport mechanism adapted to automatically transport documents inserted into the document intake port along the scanning pathway and to expel scanned documents from the document ejection port.

4. The scanning tablet computer of claim 1, wherein the image scanner is located along the scanning pathway and is adapted to scan a document while the document is traveling along the scanning pathway.

5. The scanning tablet computer of claim 1, further comprising one or more features selected from the group consisting of a notification light, a front-facing camera, a home button, a headphone jack, a charging port, a rear-facing camera, a camera flash, external control buttons, an external power button, and an external speaker.

6. The scanning tablet computer of claim 1, further comprising software that is operative to save scanned documents to a particular folder or to selectable ones of several folders in the tablet memory.

7. The scanning tablet computer of claim 1, further comprising software that is operative to save scanned documents in a categorical manner.

8. The scanning tablet computer of claim 1, further comprising a stylus adapted for use in marking on scanned documents saved in the tablet memory.

9. The scanning tablet computer of claim 8, wherein the stylus is adapted to permit a user to choose a mode of operation selected from the group consisting of writing and highlighting.

10. The scanning tablet computer of claim 9, wherein the stylus is adapted to permit a user to select from different colors in addition to choosing a mode of operation.

11. The scanning tablet computer of claim 8, further comprising a stylus dock in the tablet body.

12. The scanning tablet computer of claim 11, wherein the stylus dock is in communication with the power source such that the stylus will be recharged while residing in the dock.

13. A tablet computer with integrated document scanning functionality, comprising:
a tablet body;
a display screen visible on the tablet body;
a microprocessor, memory and a power source located within the tablet body;
a scanning pathway passing through the tablet body, the scanning pathway having a document intake port at one end of the tablet body and a document ejection port located at the opposite end of the tablet body;
an image scanner integrated into the tablet body and located along the scanning pathway, the image scanner including a motorized document transport mechanism adapted to automatically transport documents inserted into the document intake port along the scanning pathway and past the image scanner for scanning while in motion, and to expel scanned documents from the document ejection port; and
operating system software stored in tablet memory for controlling document scanning and other functions of the scanning tablet.

14. The tablet computer of claim 13, further comprising one or more features selected from the group consisting of a notification light, a front-facing camera, a home button, a headphone jack, a charging port, a rear-facing camera, a camera flash, external control buttons, an external power button, and an external speaker.

15. The tablet computer of claim 13, further comprising software that is operative to save scanned documents to a particular folder or to selectable ones of several folders in the tablet memory.

16. The tablet computer of claim 13, further comprising software that is operative to save scanned documents in a categorical manner.

17. The tablet computer of claim 13, further comprising a stylus adapted for use in marking on scanned documents saved in the tablet memory.

18. The tablet computer of claim 17, wherein the stylus is adapted to permit a user to choose a mode of operation selected from the group consisting of writing and highlighting.

19. The tablet computer of claim 18, wherein the stylus is adapted to permit a user to select from different colors in addition to choosing a mode of operation.

20. The tablet computer of claim 19, wherein the stylus includes a transmitter that transmits user selections to the tablet.
